(19) United States
(12) Patent Application Publication
(10) Pub. No.: US 2015/0084936 A1
(43) Pub. Date: Mar. 26, 2015

(54) METHOD AND APPARATUS FOR DRAWING THREE-DIMENSIONAL OBJECT

(71) Applicant: Samsung Electronics Co., Ltd., Gyeonggi-do (KR)

(72) Inventors: Yu-dong Bae, Gyeonggi-do (KR); Byung-jik Kim, Gyeonggi-do (KR); Je-in Yu, Seoul (KR); Jin-hyoung Park, Gyeonggi-do (KR)

(21) Appl. No.: 14/494,279

(22) Filed: Sep. 23, 2014

(30) Foreign Application Priority Data
Sep. 23, 2013 (KR) 10-2013-0112858

(51) Int. Cl. G06T 19/20; G06F 3/0354; G06F 3/01

(52) U.S. Cl. CPC G06T 19/20; G06F 3/017; G06F 3/016; G06F 3/03545
USPC 345/179

(57) ABSTRACT

A method of drawing a three-dimensional (3D) object on a user terminal is provided. The method includes displaying a 3D space including a two-dimensional (2D) or 3D object on the user terminal, obtaining vector information regarding a depthwise direction in the 3D space based on a user's gesture performed across a body of an electronic pen, and performing a 3D drawing function on the 2D or 3D object, based on the vector information.

### PRIORITY

This application claims priority under 35 USC §119(a) to Korean Patent Application No. 10-2013-0112858, filed in the Korean Intellectual Property Office on Sep. 23, 2013, the entire disclosure of which is incorporated herein by reference.

### BACKGROUND

1. Field of the Invention

The present invention generally relates to a method and apparatus for drawing a three-dimensional (3D) object on a user terminal by using an electronic pen.

2. Description of the Related Art

Touch screens that have been widely used in user terminals, such as smartphones, provide an interface for intuitively manipulating the user terminals. In general, touch screens are optimized to display two-dimensional (2D) images thereon. In order to express a three-dimensional (3D) space defined with X, Y, and Z axes, 2D images obtained by rendering the 3D space are displayed on a touch screen of a user terminal.

Since a user's touch input on a touch screen is a 2D input with coordinates (x, y), the coordinates (x, y) are easy to manipulate on the touch screen, but a coordinate ‘z’ is difficult to manipulate on the touch screen. In the related art, in order to control a coordinate ‘z’ in a 3D space, a view of the 3D space is converted into a plane defined with the X and Z axes or the Y and Z axes, and the coordinate ‘z’ is controlled through a user's touch input. In addition, an additional input window or tool for controlling a coordinate ‘z’ is displayed on a touch screen. However, the above methods are inconvenient to manipulate and do not provide an intuitive interface to users.

### SUMMARY

The present invention has been made to address the above problems and disadvantages, and to provide at least the advantages described below. Accordingly, an aspect of the present invention provides an intuitive interface that is more convenient to draw a three-dimensional (3D) object on a user terminal by using an electronic pen.

According to an aspect of the present invention, a method of drawing a three-dimensional (3D) object on a user terminal includes displaying a 3D space including a two-dimensional (2D) or 3D object on the user terminal; obtaining vector information regarding a depthwise direction in the 3D space based on a user's gesture performed across a body of an electronic pen; and performing a 3D drawing function on the 2D or 3D object, based on the vector information.

According to another aspect of the present invention, a user terminal includes a user interface for displaying a 3D space including a 2D or 3D object; and a processor for obtaining vector information regarding a depthwise direction in the 3D space based on a user's gesture performed across a body of an electronic pen, and performing a 3D drawing function on the 2D or 3D object based on the vector information.

### BRIEF DESCRIPTION OF THE DRAWINGS

These and/or other aspects features and advantages of the present invention will become apparent and more readily appreciated from the following description of the embodiments, taken in conjunction with the accompanying drawings, in which:

FIG. 1 is a flowchart of a method of drawing a three-dimensional (3D) object, according to an embodiment of the present invention;

FIG. 2 is a flowchart of a method of drawing a 3D object, according to another embodiment of the present invention;

FIG. 3 is a block diagram of a user terminal according to an embodiment of the present invention;

FIG. 4 is a block diagram of an electronic pen according to an embodiment of the present invention;

FIG. 5 is a block diagram of an electronic pen according to another embodiment of the present invention;

FIGS. 6A and 6B are diagrams illustrating a process of selecting a 3D object, according to an embodiment of the present invention;

FIGS. 7 to 13 are diagrams illustrating 3D drawing functions according to embodiments of the present invention;

FIG. 14 illustrates an electronic pen according to another embodiment of the present invention;

FIG. 15 illustrates an electronic pen according to another embodiment of the present invention; and

FIG. 16 is a diagram illustrating an electronic pen and a user terminal according to another embodiment of the present invention.

### DETAILED DESCRIPTION OF EMBODIMENTS OF THE PRESENT INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

In the present description, general terms that have been widely used are selected, if possible, in consideration of functions of the present invention, but non-general terms may be selected according to the intentions of technicians in the this art, precedents, or new technologies, etc. Also, some terms may be arbitrarily chosen. In this case, the meanings of these terms will be explained in corresponding parts of the present disclosure in detail. Thus, the terms used herein should be defined not based on the names thereof but based on the meanings thereof and the whole context of the present invention.

In the present description, it should be understood that terms, such as ‘include’ or ‘have,’ etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Also, the terms, such as ‘unit’ or ‘module’, etc., should be understood as a unit that processes at least one function or operation and that may be embodied in hardware, software, or a combination thereof.

As used here, the term ‘user terminal’ means an apparatus having a function of displaying images, and may be embodied as a smartphone, a Personal Digital Assistant (PDA), a tablet Personal Computer (PC), a lap-top computer, a Head-Mounted Display (HMD), a Digital Multimedia Broadcasting (DMB) system, a Portable Multimedia Player (PMP), a navigation device, a digital camera, digital Consumer Electronics (CE) appliances, etc. Examples of a digital CE appliance may include, but are not limited to, a Digital Television (DTV), an Internet Protocol TV (IPTV), a refrigerator having a display function, an air conditioner having a display function, and a printer having a display function. The term ‘3D space’ means a virtual space displayed on a user terminal. The term ‘3D drawing’ should be understood as a comprehensive term including a process of producing a 3D object in a 3D space, a process of editing a produced 3D object, and a process of extracting or modifying information regarding physical attributes (e.g., the shape, form, size, colors, etc.) of a two-dimensional (2D) or 3D object.

As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments of the present invention will be described with reference to the accompanying drawings.

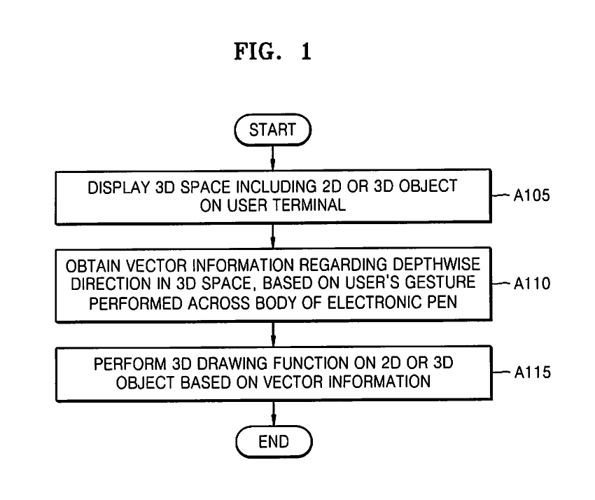

FIG. 1 is a flowchart of a method of drawing a 3D object, according to an embodiment of the present invention.

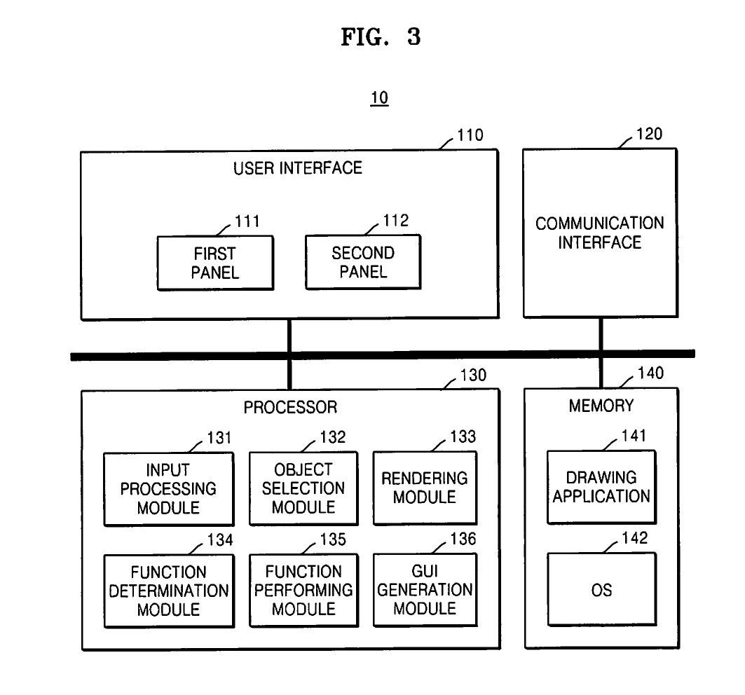

First, a user terminal 10 illustrated in FIG. 3 displays a 3D space including a 2D or 3D object thereon in step A105. The user terminal 10 displays 2D images obtained by rendering the 3D space. For example, 2D images viewed from various viewpoints (e.g., a perspective view, a plan view, a front view, etc.) of the 3D space may be displayed.

A 3D display may be used to definitely display a 3D space. For example, for the 3D display, the user terminal 10 may produce a left-viewpoint image and a right-viewpoint image and display a stereoscopic 3D image with the left-viewpoint image and the right-viewpoint image.

At least one 2D or 3D object may be included in the 3D space. In one embodiment, a 2D or 3D object is an object to which a 3D drawing function is to be applied.

The user terminal 10 displays menu items corresponding to the 3D drawing function. For example, the user terminal 10 may display menu items such as an icon for drawing lines, an icon for drawing planes, a palette icon for selecting colors, an icon for extracting object attributes, etc., but embodiments of the present invention are not limited thereto.

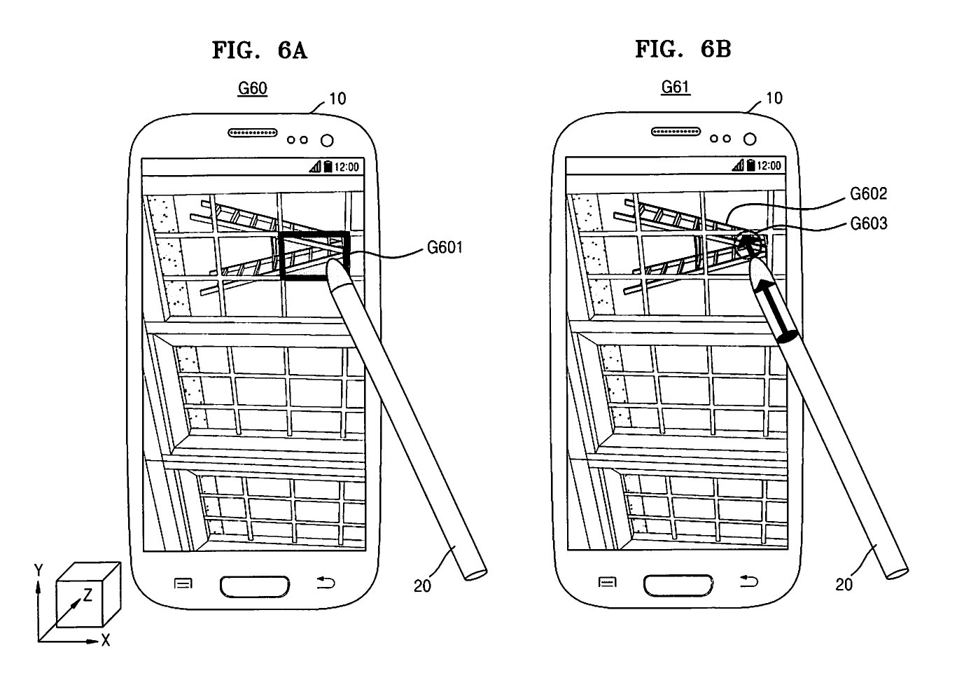

The user terminal 10 obtains vector information regarding a depthwise direction in the 3D space, based on a user's gesture performed across the body of an electronic pen 20 illustrated in FIG. 6 in step A110. The user may make an input regarding the depthwise direction, i.e., a Z-axis direction, by sweeping down or up across the body of the electronic pen 20. Here, the vector information regarding the depthwise direction in the 3D space includes at least one of information regarding the direction of a user input and information regarding the size of the user input. The information regarding the direction of the user input may be expressed with one bit to indicate whether the direction of the user input is a +Z-axis direction or a −Z-axis direction. For example, the +Z-axis direction may be expressed as ‘1’, and the −Z-axis direction may be expressed as ‘0’. The information regarding the size of the user input may be information regarding the length of the gesture or information regarding the speed of the gesture. The information regarding the size of the user input may be omitted according to an embodiment of the present invention.

The manner of using the electronic pen 20 may be classified into an active manner in which the electronic pen 20 senses a user's gesture by using a power source, and a passive manner in which the user terminal 10 itself senses a user's gesture on the electronic pen 20. In the active manner, the electronic pen 20 transmits information regarding the user's gesture to the user terminal 10, and the user terminal 10 obtains vector information by receiving the information regarding the user's gesture. In the passive manner, the user terminal 10 itself obtains vector information by sensing the user's gesture on the electronic pen 20.

In one embodiment, a user input using the electronic pen 20 may be a 3D input in which a 2D input of coordinates (x, y) may be input according to a general method and an input of a coordinate ‘z’ may be input through a user's gesture on the body of the electronic pen 20.

The user terminal 10 performs the 3D drawing function on the 2D or 3D object displayed on the user terminal 10, based on the vector information in step A115. The 3D drawing function may be, for example, an effect of extruding an object, an effect of absorbing at least a portion of an object into the electronic pen 20, an effect of extracting colors of an object, an effect of shrinking or expanding the shape of an object, an effect of increasing the volume of an object, or an effect of ejecting either an object absorbed into an electronic pen beforehand or colors of an object extracted beforehand from a virtual nib of an electronic pen, but is not limited thereto.

In one embodiment, the type of a 3D drawing function may be selected by a user. For example, when the user selects an extruding function on the user terminal 10, the user terminal 10 extrudes an object based on obtained vector information. As described above, menu items related to the 3D drawing function may be displayed on the user terminal 10. The menu items may be shortcut icons.

In another embodiment, 3D drawing functions performed based on vector information may be defined in units of objects. For example, a 3D drawing function performed based on vector information may be mapped to an object together with visual information (e.g., the shape, form, colors, etc.) regarding the object. For example, if it is assumed that an object is water contained in a cup, a 3D drawing function of absorbing the water into an electronic pen based on vector information may be mapped to the water. Examples of the 3D drawing function will be apparent from a description and drawings below.

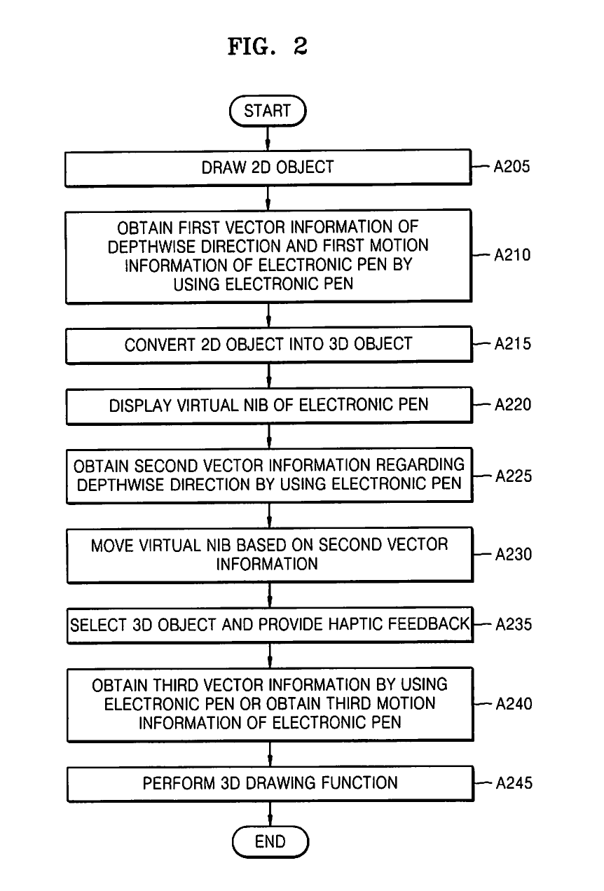

FIG. 2 is a flowchart of a method of drawing a 3D object, according to another embodiment of the present invention. The current embodiment may be based on the above descriptions.

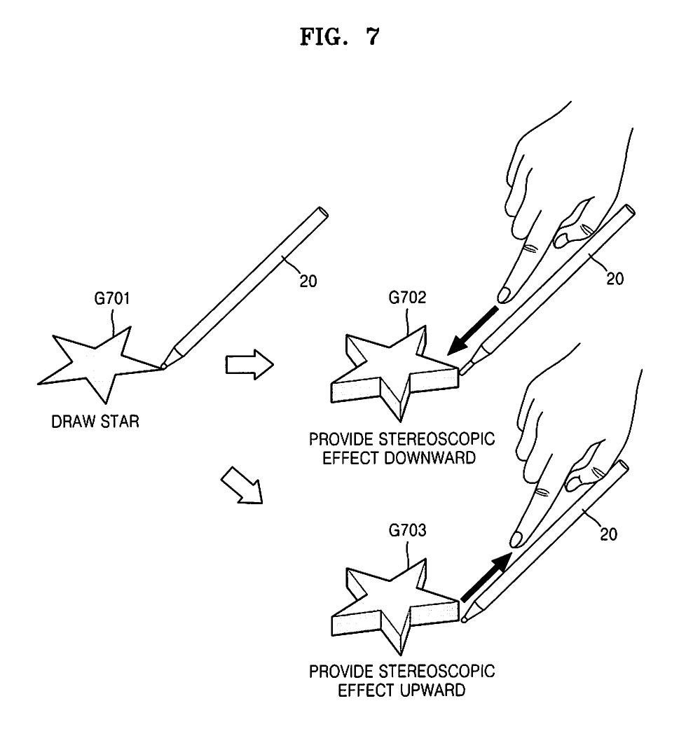

Referring to FIGS. 2 and 3, the user terminal 10 draws a 2D object in step A230. For example, the user terminal 10 draws a 2D object based on a user input using the electronic pen 20. For example, a 2D star G701, which is a 2D object illustrated in FIG. 7, may be drawn by physically moving the electronic pen 20. In other words, the user terminal 10 draws a 2D object based on a change in a 2D input of coordinates (x, y) using the electronic pen 20. The 2D star G701, which is a 2D object, is displayed on the user terminal 10.

Then, the user terminal 10 obtains first vector information of a depthwise direction and first motion information regarding a physical motion of the electronic pen 20 by using the electronic pen 20 in step A210. The first motion information regarding the physical motion of the electronic pen 20 includes information regarding a 2D input of coordinates (x, y) on the user terminal 10 but is not limited thereto. For example, when the electronic pen 20 contacting a screen of the user terminal 10 is separated from the user terminal 10, the first motion information may includes information regarding a moving direction, a moving distance, a moving speed, or acceleration of the electronic pen 20. When the electronic pen 20 rotates with respect to the body thereof, the first motion information includes information regarding a rotation angle or a rotation angular speed. The first motion information may further include information regarding the posture of the electronic pen 20. For example, the first motion information may include inclination information regarding an angle at which the electronic pen 20 is inclined, based on the depthwise direction in the screen of the user terminal 10.

Then, the user terminal 10 converts the 2D object into a 3D object, based on the first vector information and the first motion information in step A215. When a value of the physical motion of the electronic pen 20 that is determined based on the first motion information is less than a threshold, i.e., when the physical motion is determined to be substantially negligible, the user terminal 10 may neglect the first motion information and convert the 2D object into the 3D object based only on the first vector information.

FIG. 7 is a diagram illustrating a process of drawing a 3D object by extruding a 2D object based on first vector information, according to an embodiment of the present invention. It will be obvious to users that although all objects, for example, the 2D star G701, a 3D star G702, and a 3D star G703, illustrated in FIG. 7 are objects displayed on a user terminal, the user terminal is not illustrated in FIG. 7 for convenience of explanation.

The 3D star G702 is obtained by extruding the 2D star G701 in a direction that becomes distant from an electronic pen 20 (or providing a stereoscopic effect downward), and the 3D star G703 is obtained by extruding the 2D star G701 in a direction that becomes close to the electronic pen 20 (or providing a stereoscopic effect upward). A direction in which the 2D star G701 is to be extruded is determined based on the first vector information. For example, when the first vector information represents a sweep down operation of sweeping down across the body of the electronic pen 20 to indicate a direction in which depth increases, the 3D star G702 is drawn by extruding the 2D star G701 in a direction that becomes distant from the electronic pen 20. In contrast, when the first vector information represents a sweep up operation of sweeping up across the body of the electronic pen 20 to indicate a direction that decreases a depth, the 3D star G703 is drawn by extruding the 2D star G701 in the direction that the 2D star G701 becomes close to the electronic pen 20.

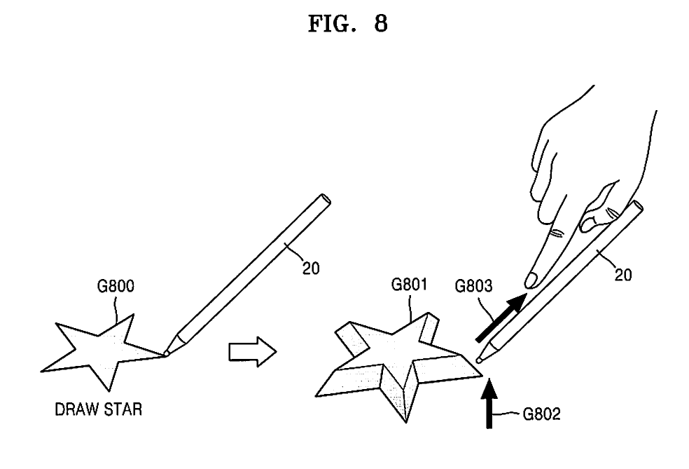

FIG. 8 is a diagram illustrating a process of drawing a 3D object by extruding a 2D object based on first vector information and first motion information, according to another embodiment of the present invention. In FIG. 8, the 2D object is extruded based on the first motion information and the first vector information while the electronic pen 20 is physically moved, unlike in FIG. 7.

A user lifts the electronic pen 20 in a direction that becomes distant from the user terminal 10 of FIG. 3 while making a gesture G803 of sweeping up across the body of the electronic pen 20. The first motion information obtained by the user terminal 10 includes information regarding a physical motion G802 of the electronic pen 20. For example, the first motion information may include information regarding a distance, direction, speed, or acceleration of the physical motion G802.

The user terminal 10 extrudes a 2D star G800 in a direction that becomes close to the electronic pen 20, based on the first vector information. In this case, a cross-sectional area of the 2D star G800 that is to be extruded is decreased according to a physical motion of the electronic pen 20. For example, the user terminal 10 extrudes the 2D star G800 based on the first vector information while reducing the cross-sectional area of the 2D star G800 based on the first motion information. The user terminal 10 may use the information regarding the speed or acceleration of the physical motion G802 to determine the cross-sectional area of the 2D star G800. For example, the user terminal 10 may decrease the cross-sectional area of the 2D star G800 in proportion to the speed or acceleration of the physical motion G802. Thus, the difference between the cross-sectional areas of the top surface and the bottom surface of the 3D star G801 is proportional to the speed or acceleration of the physical motion G802.

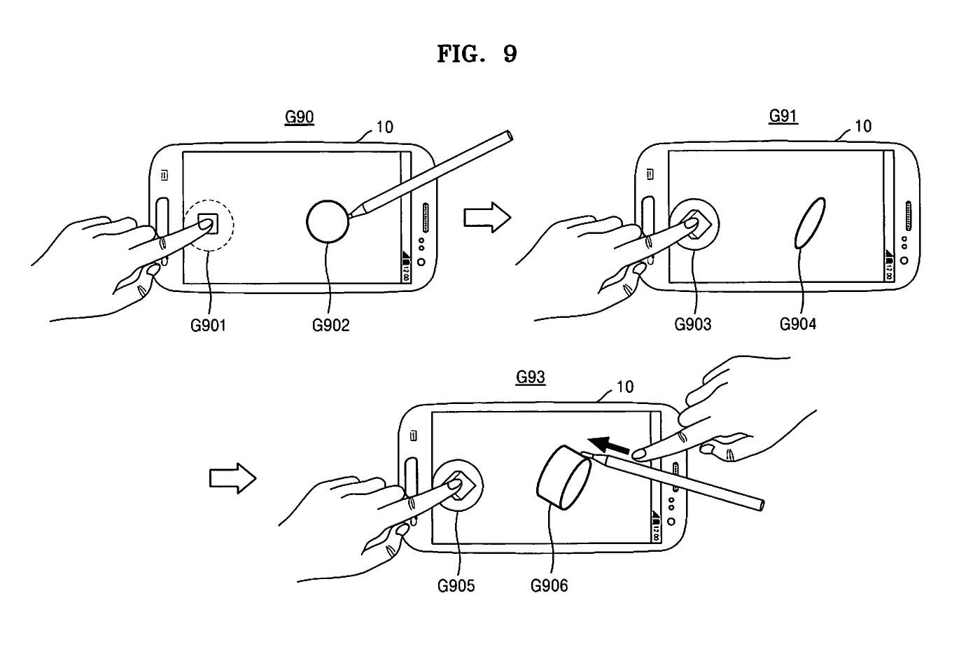

FIG. 9 is a diagram of a process of extruding a 2D object G902 based on first vector information while adjusting a view of a 3D space according to a user's touch input, according to another embodiment of the present invention. When a user input, the type of which is different from that of an input using the electronic pen 20, is sensed, on image G90, the user terminal 10 of FIG. 3 displays a 3D tool G901 for controlling the view of the 3D space. For example, when a touch input with a user's finger is sensed, the user terminal 10 displays the 3D tool G901 with respect to the location of each pixel on which the touch input is sensed. The 3D tool G901 illustrated in FIG. 9 corresponds to a top surface of a rectangular hexahedron. The 3D tool G901 is not, however, limited to the rectangular hexahedron and may be displayed in a different shape. For example, the 3D tool G901 may be displayed as a joy stick or three-axis coordinates.

The user terminal 10 changes the view of the 3D space as a user drags the 3D tool G901. For example, when the user drags the 3D tool G901 to the right, a side surface G903 of the rectangular hexahedron is displayed on image G91. Thus, it is easier to determine a view to which the view of the 3D space is changed. From the user's viewpoint, the 3D tool G901 and the 2D object G902 are viewed to move in synchronization with each other.

When the user ends the touch input using the 3D tool G901, the 3D tool G901 disappears and the view of the 3D space returns to a default value.

In image G93, the user sweeps down across the body of the electronic pen 20 while dragging the 3D tool G905. The user terminal 10 obtains the first vector information through the user's sweep down operation. The user terminal 10 draws a 3D object G906 by extruding a 2D object G904 obtained by rotating the 2D object G902 based on the first vector information. The user checks the height of the 3D object G906 in real time as the 2D object G904 is extruded. Thus, it is possible to solve a problem that the user cannot check a visual effect of extruding the 2D object G902 in a state the view of the 3D space is not changed, as illustrated in an image G90, even if the 2D object G902 is extruded.

Referring back to FIG. 2, the user terminal 10 displays a virtual nib of the electronic pen 20 on a location on the user terminal 10 that the electronic pen 20 contacts in step A220. For example, the user terminal 10 displays the virtual nib of the electronic pen 20 on a location of coordinates (x,y) by using a 2D input using the electronic pen 20 at coordinates (x,y). In step A220, a value ‘z’ of the virtual nib may be set to be the same as a value ‘0’ of the depth of the screen of the user terminal 10. It would be apparent to those of ordinary skill in the art that the virtual nib is also applicable to steps A205 to A215 in one embodiment.

Then, the user terminal 10 obtains second vector information regarding a depthwise direction in the 3D space by using the electronic pen 20 in step A225. The user terminal 10 may obtain the second vector information through a sweeping up or sweeping down gesture across the body of the electronic pen 20 as described above.

Then, the user terminal 10 moves the virtual nib in the depthwise direction in the 3D space, based on the second vector information in step A230. For example, when the second vector information represents a direction in which depth increases, the virtual nib is moved in this direction, thereby enabling the virtual nib to move to a desired depth.

Then, the user terminal 10 selects a 3D object and provides haptic feedback in step A235. The user terminal 10 selects a 3D object that contacts the virtual nib as the virtual nib is moved in the depthwise direction. When the virtual nib and the 3D object contact each other, the user terminal 10 outputs a control signal for providing the haptic feedback directly or via the electronic pen 20. The haptic feedback may be provided in various ways. For example, the haptic feedback may be provided by generating vibration, a displacement, or electric stimulus.

FIG. 6 is a diagram illustrating a process of selecting a 3D object, according to an embodiment of the present invention. Referring to FIG. 6, a 3D space, including a window and a ladder G602 outside the window, is displayed on the user terminal 10. In a left image G60, when the electronic pen 20 contacts the user terminal 10, an object having a depth ‘0’ is selected. That is, the user terminal 10 selects a portion of glass G601 of the window based on a 2D input using the electronic pen 20. However, a user may desire to select the ladder G602 outside the window rather than the portion of glass G601. In this case, the portion of glass G601 and the ladder G602 have different depth values ‘z’ but have the same coordinates (x, y). Thus, according to a related art, the user experiences difficulties in selecting the ladder G602.

In one embodiment of the present invention, as illustrated in a right image G61, an effect of causing a virtual nib G603 to protrude from the electronic pen 20 is displayed in a depthwise direction in the 3D space through a sweeping down gesture across the electronic pen 20. When the virtual nib G603 is moved in the depthwise direction and then contacts the ladder G602, the user terminal 10 outputs a control signal to provide the user with haptic feedback and selects the ladder G602.

Thus, the user may easily and intuitively select and manipulate a desired object by making a sweeping up/down gesture on the electronic pen 20 regardless of a depth in the 3D space in which the desired object is located. Referring back to FIG. 2, the user terminal 10 obtains third vector information through the user's gesture performed across the body of the electronic pen 20 or obtains third motion information through a physical motion of the electronic pen 20 in step A240. The third vector information and the third motion information will be obvious from the above description regarding step A210. However, it would be apparent to those of ordinary skill in the art that the third vector information and the third motion information may be simultaneously obtained.

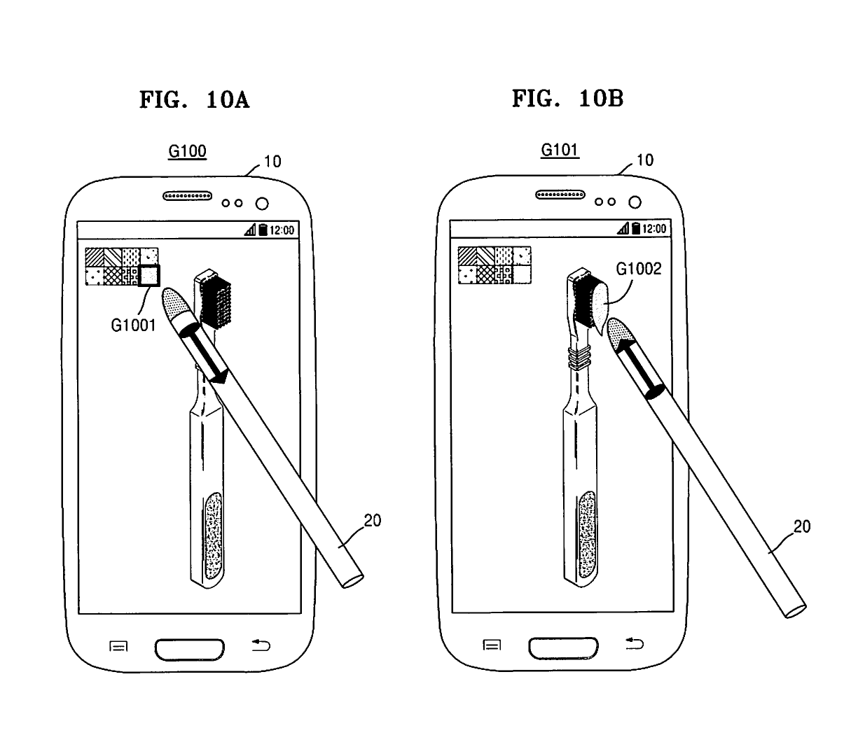

The user terminal 10 performs a 3D drawing function on the selected 3D object based on at least one of the third vector information and the third motion information in step A245. 3D drawing functions performed on a 3D object are illustrated in FIGS. 10 to 13.

Referring to FIGS. 10A and 10B, a 3D space, including a toothbrush and a palette object, is displayed on the user terminal 10. In a left image G100, a first color G1001 is selected from the palette by using the electronic pen 20. The user terminal 10 obtains vector information through a sweeping up gesture across the electronic pen 20. The user terminal 10 determines that the vector information represents a direction in which depth in the 3D space is reduced and extracts color information regarding the selected first color G1001. Thus, a user understands that a 3D drawing function of absorbing paints from the palette into the electronic pen 20 is performed.

After the color information regarding the first color G1001 is extracted, the electronic pen 20 is physically moved. For example, the electronic pen 20 is separated from the user terminal 10 and then contacts the user terminal 10 on the head of the toothbrush, as illustrated in a right image G101. Then, the user terminal 10 obtains vector information when a sweeping down gesture across the electronic pen 20 is performed. The user terminal 10 determines that the obtained vector information represents a direction that increases the depth in the 3D space and draws an object G1002 having the extracted first color G1001 on a location corresponding to the head of the toothbrush. Thus, the user understands that a 3D drawing function of ejecting the toothpaste having the first color G1001 from the electronic pen 20 is performed. Although a case in which a color among various object attributes is extracted or ejected is described in the current embodiment, another object attribute (e.g., a shape or volume) may be extracted and an object having the shape or volume may be drawn on a location that the moved electronic pen 20 contacts according to another embodiment.

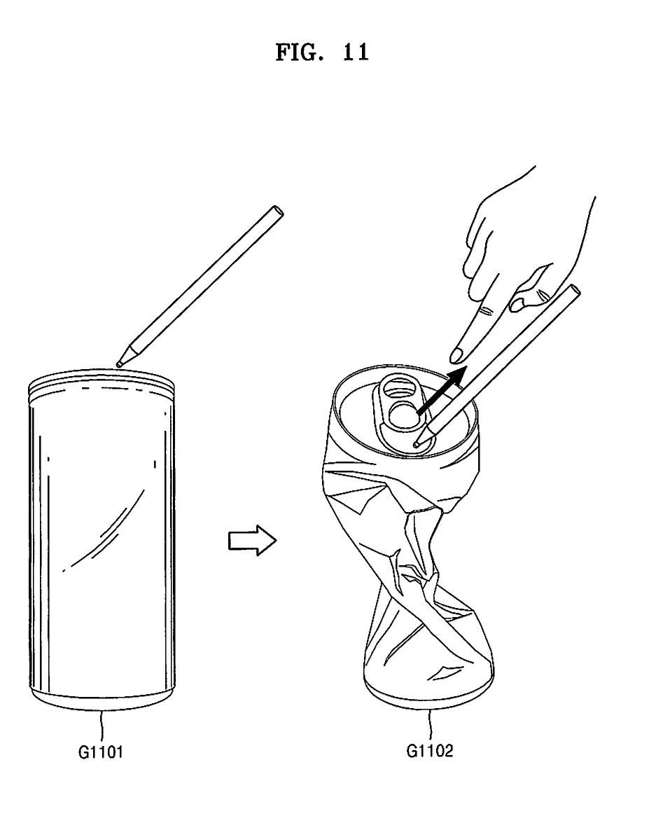

FIG. 11 is a diagram illustrating a 3D drawing function according to an embodiment of the present invention, in which a left can G1101 and a right can G1102 are 3D objects that are sequentially displayed on the user terminal 10 of FIG. 3 according to time. However, it would be apparent to those of ordinary skill in the art that only the 3D objects, and not the terminal 10, are illustrated for convenience of explanation.

First, the user terminal 10 selects an opening (not shown) in the top of the left can G1101 displayed on the user terminal 10 by using a virtual nib of the electronic pen 20 of FIG. 6. If a depth of the opening has a value other than ‘0’, the user may move the virtual nib of the electronic pen 20 to the opening by making a sweeping up/down gesture across the electronic pen 20.

When the opening is selected, the user terminal 10 obtains vector information according to the user's sweeping up/down gesture across the electronic pen 20. The user terminal 10 performs a 3D drawing function on the left can G1101 based on the vector information. When the 3D drawing function is performed on the left can G1101, an effect of denting the left can G1101 to become the right can G1102 is derived. That is, the right can G1102 is a result of performing the 3D drawing function on the left can G1101. For example, the user terminal 10 determines whether the vector information represents a direction that decreases the depth in a 3D space. If the vector information represents the direction that decreases the depth in the 3D space, the user terminal 10 dents the left can G1101 to become the right can G1102.

In one embodiment, the degree to which the left can G1101 is to be dented may be determined by the size of the vector information. For example, as the size of the vector information increases, the user terminal 10 may perform an effect of applying an increased internal pressure (i.e., an increased suction effect) to the left can G1101. That is, the denting as shown in the right can G1102 is caused by the suction effect, and the degree of the denting is determined by the degree of the suction effect. The size of the vector information may be proportional to the length of the user's sweeping up gesture across the electronic pen 20.

Thus the user may see that the internal pressure in the left can G1101 decreases to dent the left can G1101 (i.e., a decreased suction effect) as the left can G1101 is absorbed into the electronic pen 20.

According to the current embodiment, when the 3D drawing function is performed on a selected 3D object, an effect of denting the shape of the selected 3D object and decreasing the volume of the selected 3D object is performed. This effect may be defined with respect to 3D objects beforehand. For example, a function having parameters related to the shape and volume of the left can G1101 may be mapped to the left can G1101 beforehand. The user terminal 10 may change the shape and volume of the left can G1101 by inputting the vector information as an input value into the function.

According to another embodiment, a user may select an effect of denting a selected 3D object from menu items. When vector information is obtained through a sweeping up gesture across the electronic pen 20, the effect of denting a 3D object, which is selected by the user, is performed.

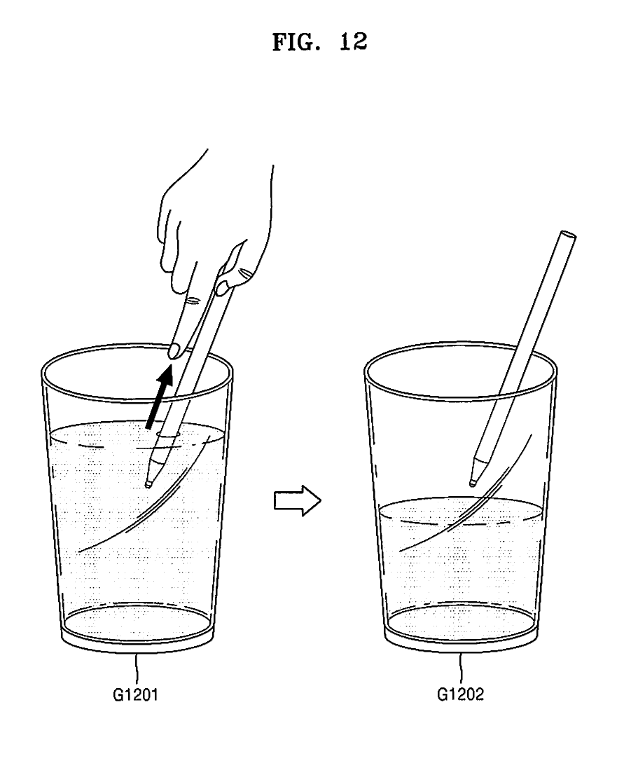

FIG. 12 is a diagram illustrating a 3D drawing function according to another embodiment of the present invention, in which an effect of absorbing a selected object is illustrated. It would be apparent to those of ordinary skill in the art that only the 3D objects are illustrated in FIG. 12 for convenience of explanation, as in FIG. 11, and not the terminal 10 itself.

First, the user terminal 10 moves a virtual nib of the electronic pen 20 to the opening at the top of the left cup G1201 displayed on the user terminal 10. Then, the virtual nib of the electronic pen 20 is moved into the liquid in the left cup G1201 according to a sweeping down gesture across the electronic pen 20. Thus, the liquid in the left cup G1201 may be selected on the user terminal 10. In this case, a user may see that the electronic pen 20 is plunged into the liquid in the left cup G1201, as illustrated in FIG. 12.

The user terminal 10 obtains vector information according to the user's sweeping up gesture across the electronic pen 20. The user terminal 10 performs the 3D drawing function of absorbing the liquid in the left cup G1201 based on the vector information. For example, the user terminal 10 determines whether the vector information represents a direction that decreases a depth in a 3D space. When the vector information represents the direction that decreases the depth in the 3D space, the user terminal 10 decreases the volume of the liquid in the left cup G1201. In this case, the user may see that the electronic pen 20 operates like a pipette to absorb the liquid in the left cup G1201. That is, after liquid in the left cup G1201 is absorbed and the volume of the liquid in the left cup G1201 is decreased, the result of this absorption is shown as the right cup G1202.

In one embodiment, a degree to which the volume of the liquid is to be decreased may be determined by the size of the vector information. For example, the user terminal 10 determines the degree to which the volume of the liquid is to be decreased to be proportional to the size of the vector information. The size of the vector information may be determined by the length of the user's gesture performed on the electronic pen 20.

When a decrease in the volume of the liquid causes the virtual nib to be exposed on the surface of the liquid, the user terminal 10 stops the 3D drawing function of absorbing the liquid. For example, the user terminal 10 may compare a depth value of the surface of the liquid in the 3D space with a depth value of the virtual nib and may stop the 3D drawing function when the depth value of the water surface of the liquid is greater than the depth value of the virtual nib. The user may perform the 3D drawing function again by moving the virtual nib again into the liquid.

According to the current embodiment, the effect of decreasing the volume of a 3D object is performed when the 3D drawing function is performed. This effect may be defined with respect to 3D objects beforehand. For example, information regarding an object that is the liquid in the left cup G1201 may be set in the user terminal 10 beforehand, and a function having a parameter related to the volume of the liquid may be mapped to the liquid beforehand. The user terminal 10 changes the volume of the liquid in the left cup G1201 by inputting the vector information as an input value into the function. According to another embodiment, a user may select an effect of absorbing a selected 3D object from menu items.

The liquid absorbed into the electronic pen 20 may also be ejected from the electronic pen 20 according to a sweeping down gesture across the electronic pen 20.

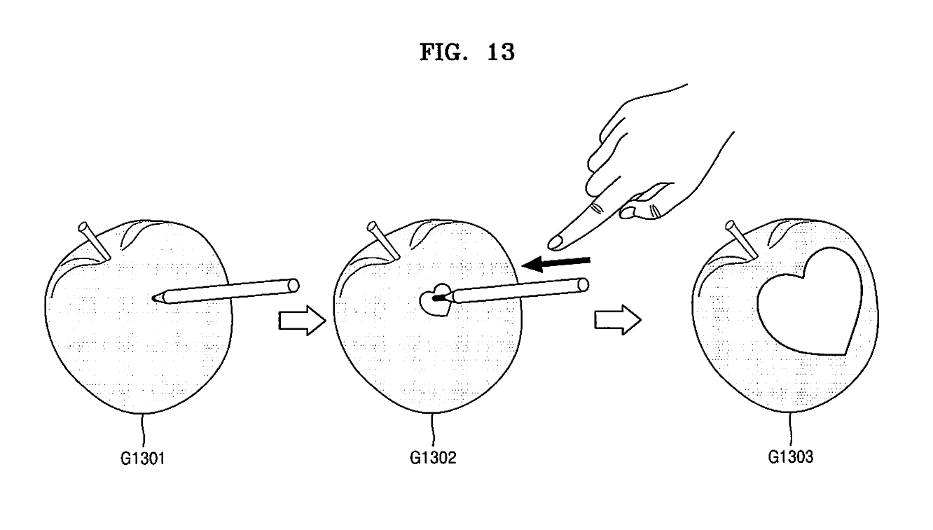

FIG. 13 is a diagram illustrating a 3D drawing function according to another embodiment of the present invention, in which an effect of sculpting a selected object is performed according to a physical motion of an electronic pen. Referring to FIG. 13, apples G1301, G1302, and G1303 are 3D objects that are sequentially displayed on the user terminal 10 of FIG. 3 according to time.

First, the user terminal 10 selects the left apple G1301 with a virtual nib of the electronic pen 20. Then, the user terminal 10 moves the virtual nib of the electronic pen 20 into the left apple G1301 according to a gesture of sweeping down across the electronic pen 20. A result of inserting the virtual nib into the left apple G1301 may be displayed as the middle apple G1302. The user terminal 10 obtains motion information according to a physical motion of the electronic pen 20. The user terminal 10 performs an effect of sculpting a selected object, based on the motion information. For example, when a user moves the electronic pen 20 in the form of a heart, the right apple G1303 is displayed on the user terminal 10. The inside of the heart in the right apple G1303 is hollowed out by a depth of the virtual nib.

The 3D drawing function of sculpting a selected object may be mapped to the left apple G1301 beforehand or may be selected from menu items displayed on the user terminal 10 by a user.

In the current embodiment, various types of haptic feedback may be provided. For example, the user terminal 10 or the electronic pen 20 may provide a first haptic feedback when the left apple G1301 is selected using the virtual nib, provide a second haptic feedback when the virtual nib is inserted into the middle apple G1302, and provide a third haptic feedback when the inside of the middle apple G1302 is sculpted according to a physical motion of the electronic pen 20. The first to third haptic feedback may be different from one another. For example, the first to third haptic feedback may be provided by changing a vibration pattern or pulses. Otherwise, the first haptic feedback may be provided using an electrical stimulus, the second haptic feedback may be provided using vibration, and the third haptic feedback may be provided using a force (frictional force, etc.). That is, the user terminal 10 or the electronic pen 20 may provide various types of haptic feedback according to the type of an event generated during a 3D drawing.

It would be apparent to those of ordinary skill in the art that the embodiments of FIGS. 7 to 13 described above are just examples of explaining 3D drawing functions, the scope of the present invention is not limited thereto, and other 3D drawing functions may be performed based on the above description.

Referring now to FIG. 3, FIG. 3 is a block diagram of a user terminal 10 according to an embodiment of the present invention. In FIG. 3, general constitutional elements of the user terminal 10 are not illustrated.

Referring to FIG. 3, the user terminal 10 includes a user interface 110, a communication interface 120, a processor 130, and a memory 140.

The memory 140 includes an operating system (OS) 142 configured to drive the user terminal 10, and a drawing application 141 operating in the OS 142. In one embodiment, the drawing application 141 may be embedded in the OS 142. The OS 142 and the drawing application 141 are operated by the processor 130.

The memory 140 may include at least one type of storage medium, such as a flash memory type storage medium, a hard disk type storage medium, a multimedia card micro type storage medium, a card type memory (e.g., an SD or XD memory), a Random Access Memory (RAM), a Static RAM (SRAM), a Read-Only Memory (ROM), an Electrically Erasable Programmable Read-Only Memory (EEPROM), a Programmable ROM (PROM), a magnetic memory, a magnetic disk, and an optical disk.

The user interface 110 is an interface via which the user terminal 10 is manipulated by a user or a result of processing data by the processor 130 is displayed. According to an embodiment of the present invention, the user interface 110 includes a first panel 111 and a second panel 112.

The first panel 111 includes a touch screen. For example, the first panel 111 includes various sensors for sensing a touch on or in the proximity of the touch screen. A tactile sensor is an example of a sensor for sensing a touch on the touch screen. The tactile sensor is a sensor capable of sensing a touch on an object to a degree that a human can sense or more. The tactile sensor is capable of sensing various information such as the toughness of a contacted surface, the hardness of a contacted object, the temperature of a contacted position, etc.

A proximity sensor is another example of a sensor for sensing a touch on the touch screen. The proximity sensor is a sensor capable of sensing an object that approaches a detection surface or an object near the detection surface by using a force of an electromagnetic field or infrared rays without physical contact. Thus, the proximity sensor has a much longer lifetime and a much higher utilization rate than contact type sensors.

Examples of the proximity sensor include a transmissive photoelectric sensor, a direct reflective photoelectric sensor, a mirror reflective photoelectric sensor, a high-frequency oscillator proximity sensor, an electrostatic capacitance type proximity sensor, a magnetic type proximity sensor, an infrared ray proximity sensor, etc.

The first panel 111 may include at least one among a Liquid Crystal Display (LCD), a Thin Film Transistor-Liquid Crystal Display (TFT-LCD), an Organic Light-Emitting Diode Display, a flexible display, and a 3D display. The first panel 111 may include two or more display devices according to the type of the user terminal 10. The touch screen may be configured to sense not only the location of a touch input and a touched area but also the pressure of the touch input. Also, the touch screen may be configured to sense not only the touch (real-touch) but also a proximity touch.

The second panel 112 may be a panel that may form a magnetic field to sense an input using the electronic pen 20 according to an ElectroMagnetic Resonance (EMR) manner. If the electronic pen 20 is configured according to the active manner, the second panel 112 may be omitted. A magnetic field may be formed in at least a portion of the second panel 112 by applying a voltage to the second panel 112.

The second panel 112 includes a plurality of coils for generating a magnetic field at regular intervals. For example, in the second panel 112, a plurality of wires may be arranged in rows and columns, and a plurality of coils may be disposed at intersections of the wires arranged in columns and the wires arranged in rows. Also, both ends of the coils may be connected to the wires arranged in columns and the wires arranged in rows, respectively. Thus, the coils included in the second panel 112 generate a magnetic field when voltage is applied to the wires arranged in columns and the wires arranged in rows. However, embodiments of the present invention are not limited thereto, and a magnetic field may be generated in at least a portion of the second panel 112 according to various magnetic field generation techniques using magnets, coils, etc.

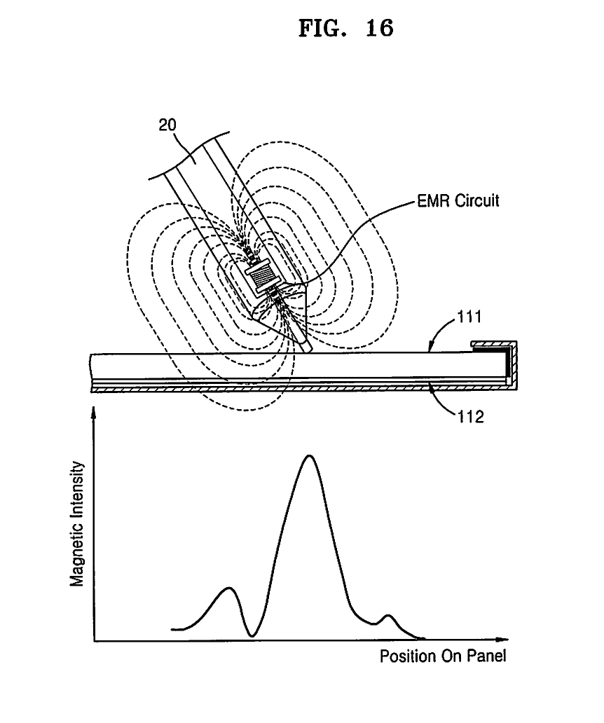

Referring to FIG. 16, the second panel 112 may contact a bottom surface of the first panel 111 and have the same size as the first panel 111. However, embodiments of the present invention are not limited thereto, and the second panel 112 may be smaller than the first panel 111 in size.

The second panel 112 may include a sensor unit (not shown) for sensing a change in the intensity of a magnetic field, caused by use of the electronic pen 20. The sensor unit of the second panel 112 senses a change in the magnetic field by using a sensor coil therein. The user terminal 10 receives the inputs using the electronic pen 20, the vector information, and the motion information described above, based on the change in the magnetic field.

For example, in a method of obtaining the vector information, two or more circuits having different oscillating frequencies are installed in an upper portion and a lower portion of the body of the electronic pen 20. When one of the two or more circuits having different oscillating frequencies is selected according to a user's gesture on the electronic pen 20, the sensor unit of the second panel 112 detects the circuit oscillating in the electronic pen 20 by changing a frequency of an input signal of the sensor coil. That is, the user terminal 10 determines whether the user's gesture with respect to the electronic pen 20 is a sweep-up gesture or a sweep-down gesture by checking whether the circuit installed in the upper portion of the electronic pen 20 or the circuit installed in the lower portion of the electronic pen 20 oscillates according to the frequency of the input signal.

For example, in a method of obtaining the motion information, the sensor unit of the second panel 112 obtains coordinates (x, y) of an input using the electronic pen 20 by detecting a location on the second panel 112 on which the intensity of the magnetic field is strongest as illustrated in FIG. 16. Also, the sensor unit of the second panel 112 may detect that the electronic pen 20 is located at a distance from the user terminal 10, based on a change in a maximum value of the intensity of the magnetic field. Also, the sensor unit of the second panel 112 obtains information regarding the angle and direction of the inclination of the electronic pen 20 by detecting a distribution of intensities of the magnetic field sensed in units of regions of the sensor coil.

Referring back to FIG. 3, the communication interface 120 includes at least one element that enables the user terminal 10 to communicate with an external device, e.g., the electronic pen 20. However, when the electronic pen 20 is configured according to the passive manner, the communication interface 120 may be omitted. For example, the communication interface 120 may include a broadcast receiving module, a mobile communication module, a wireless Internet module, a wired Internet module, a local area communication module, a location information module, etc.

The broadcast receiving module receives a broadcast signal and/or information related to a broadcast from an external broadcasting management server via a broadcast channel. Examples of the broadcast channel may include a satellite channel, a terrestrial channel, etc.

The mobile communication module exchanges a radio signal with at least one of a base station, an external terminal, and an external server in a mobile communication network. Here, the radio signal contains various types of data obtained by transmitting/receiving voice call signals, video communication call signals, or text/multimedia messages.

The wireless Internet module is a module for accessing the Internet in a wireless manner, and may be installed inside or outside the user terminal 10. The wired Internet module is a module for accessing the Internet in a wired manner.

The local area communication module is a module for local-area communication. Bluetooth, Radio Frequency Identification (RFID), Infrared Data Association (IrDA), Ultra WideBand (UWB), ZigBee, Wi-Fi Direct (WFD), Near-Field Communication (NFC), etc. may be used as local area communication technologies.

Referring again to FIG. 3, the processor 130 controls overall operations of the user terminal 10. The processor 130 controls the user interface 110, the communication interface 120, and the memory 140 by running the OS 142 or the drawing application 141 stored in the memory 140.

The processor 130 includes an input processing module 131, an object selection module 132, a rendering module 133, a function determination module 134, a function performing module 135, and a Graphical User Interface (GUI) generation module 136. The modules described above may be understood to be software blocks executed by running the OS 142 or the drawing application 141.

The input processing module 131 processes a user input by using the first panel 111 or the second panel 112. For example, the input processing module 131 obtains vector information or motion information by using a change in a magnetic field sensed by the sensor unit of the second panel 112. The object selection module 132 selects a 2D or 3D object in a 3D space, based on the vector information or the motion information received from the input processing module 131. The function determination module 134 determines a 3D drawing function to be performed based on a user input using the electronic pen 20, according to the obtained vector information or motion information. The function performing module 135 performs the 3D drawing function determined by the function determination module 134. The rendering module 133 renders the 3D space including the 2D or 3D object and outputs a result of rendering the 3D space to the user interface 110. The GUI generation module 136 generates a GUI for manipulating the user terminal 10 and outputs the GUI to the user interface 110. For example, the GUI generation module 136 generates a GUI for a menu item for selecting the 3D drawing function and outputs the GUI to the user interface 110.

The basic hardware construction and operations of the user terminal 10 have been described above. A method of drawing a 3D object, as described above, by using the user terminal 10 will be described below.

The user interface 110 displays a 3D space including a 2D or 3D object thereon. Here, the 2D or 3D object may be an object that is drawn using the electronic pen 20 beforehand.

The processor 130 obtains vector information regarding a depthwise direction in a 3D space, based on a user's gesture performed across the body of the electronic pen 20. The processor 130 may obtain motion information based on a physical motion of the electronic pen 20.

When the electronic pen 20 is configured according to the passive manner, the vector information and the motion information are obtained using the second panel 112. When the electronic pen 20 is configured according to the active manner, the vector information and the motion information are obtained using the communication interface 120.

The processor 130 uses the vector information and the motion information to select an object displayed on the user interface 110. The processor 130 displays the virtual nib on the user interface 10 in response to a 2D input of coordinates (x,y) included in the motion information. The processor 130 moves the virtual nib displayed on the user interface 110 in the lengthwise direction in the 3D space, based on the vector information obtained through a sweeping up/down gesture across the electronic pen 20. When the virtual nib moves in the depthwise direction and then contacts an object in the 3D space, the processor 130 outputs a control signal for controlling a haptic feedback via the electronic pen 20 or the user terminal 10. When the user terminal 10 provides the haptic feedback, the user terminal 10 may further include an actuator (not shown).

The processor 130 performs a 3D drawing function on an object selected using at least one of the obtained vector information and motion information.

When the 3D drawing function is a function of extruding an object, the processor 130 extrudes a selected object in a direction that becomes close to the electronic pen 20 or a direction that becomes distant from the electronic pen 20, according to a direction indicated in the vector information. If the electronic pen 20 separates from the user terminal 10, the processor 130 extrudes a selected object while changing a cross-sectional area of the object based on the motion information.

Also, the processor 130 performs an effect of absorbing at least a portion of a selected object into the electronic pen 20, based on a size or direction indicated in the vector information. The processor 130 performs an effect of extracting a color of a selected object, based on the size or direction indicated in the vector information. The processor 130 performs an effect of shrinking or expanding the shape of a selected object, based on the size or direction indicated in the vector information. The processor 130 performs an effect of increasing/decreasing the volume of a selected object, based on the size or direction indicated in the vector information. The processor performs an effect of ejecting an object absorbed into the electronic pen 20 beforehand or a color extracted beforehand from the virtual nib of the electronic pen 20, based on the size or direction indicated in the vector information.

Also, when the vector information represents a direction in which depth increases in the 3D space, the processor 130 inserts the virtual nib of the electronic pen 20 into a selected object. Then, the processor 130 performs an effect of sculpting the selected object according to a motion of the virtual nib.

The processor 130 displays a result of performing a 3D drawing function via the user interface 110. When a touch input that is different from an input using the electronic pen 20 is sensed by the user interface 110, the processor 130 displays a 3D tool for controlling a view of a 3D space displayed on the user interface 110.

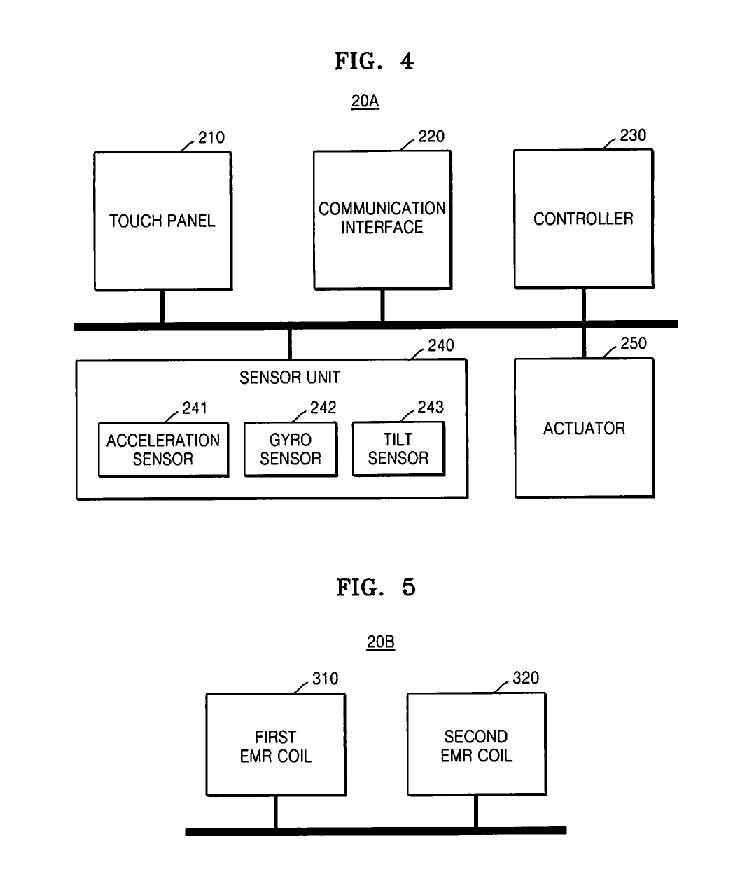

FIG. 4 is a block diagram of an electronic pen 20A operating in the active manner, according to an embodiment of the present invention. Referring to FIG. 4, the electronic pen 20A includes a touch panel 210, a communication interface 220, a controller 230, a sensor unit 240, and an actuator 250. The electronic pen 20A may further include a battery, and an interface via which power is supplied from the outside. The electronic pen 20A may further include a speaker or a microphone.

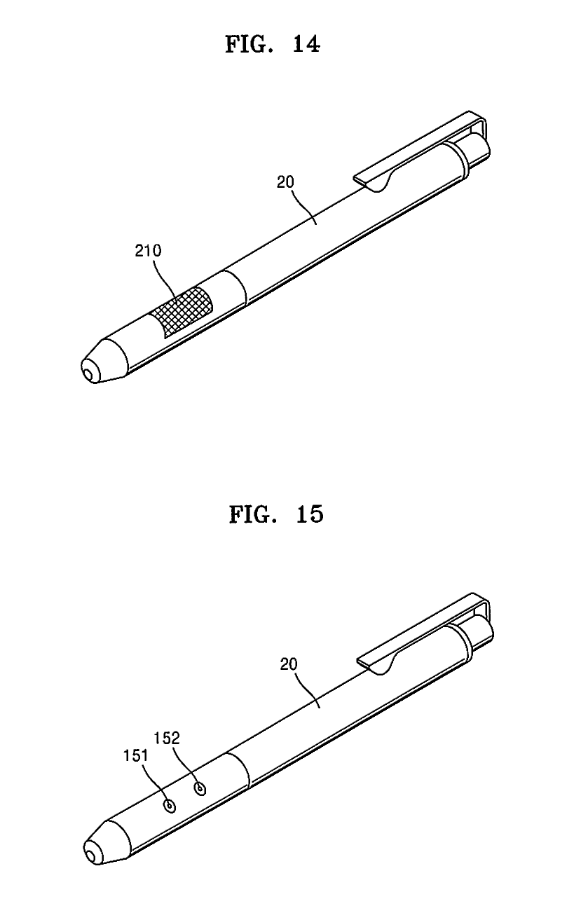

The touch panel 210 is disposed on the body of the electronic pen 20A, and senses a user's sweeping up/down gesture across the electronic pen 20A. For example, the touch panel 210 may be disposed on the body of the electronic pen 20, as illustrated in FIG. 14.

The sensor unit 240 includes an acceleration sensor 241, a gyro sensor 242, and a tilt sensor 243. The acceleration sensor 241 senses acceleration according to a physical motion of the electronic pen 20A. In one embodiment of the present invention, the acceleration sensor 241 is a multi-axis acceleration sensor. The inclination of the electronic pen 20A is detected by detecting the angle formed by a direction of the acceleration of gravity and a direction of the electronic pen 20A by using the multi-axis acceleration sensor. The gyro sensor 242 senses a rotational direction and angle when the electronic pen 20A rotates. The tilt sensor 243 detects the inclination of the electronic pen 20A. When the acceleration sensor 241 is a multi-axis acceleration sensor, the tilt sensor 243 may be omitted.

The communication interface 220 is connected to the user terminal 10 in a wired or wireless manner to transmit data to or receive data from the user terminal 10. The communication interface 220 may transmit data to or receive data from the user terminal 10 via Bluetooth. The operation of the communication interface 220 will be apparent from the above description regarding the communication interface 120 of the user terminal 10.

The actuator 250 provides haptic feedback to a user under control of the controller 230. The actuator 250 may include, for example, at least one of an Eccentric Rotation Mass (ERM) motor, a linear motor, a piezo-actuator, an ElectroActive Polymer (EAP) actuator, and an electrostatic force actuator.

The controller 230 controls overall operations of the touch panel 210, the actuator 250, the sensor unit 240, and the communication interface 220. The controller 230 transmits information regarding a user's gesture sensed by the touch panel 210 and information sensed by the sensor unit 240 to the user terminal 10 via the communication interface 220.

FIG. 5 is a block diagram of an electronic pen 20B operating in the passive manner, according to another embodiment of the present invention. Referring to FIG. 5, the electronic pen 20B includes a first EMR coil 310 and a second EMR coil 320. In the embodiment illustrated in FIG. 5, the electronic pen 20B includes two EMR coils, for example, the first and second coils 310 and 320, but more than two EMR coils may be included in the electronic pen 20B.

The first EMR coil 310 and the second EMR coil 320 may be configured as EMR circuits having different oscillating frequencies. One of the first EMR coil 310 and the second EMR coil 320 may be disposed in an upper portion of the electronic pen 20B, and the other EMR coil may be disposed in a lower portion of the electronic pen 20B. The first EMR coil 310 and the second EMR coil 320 cause a change in a magnetic field generated by the user terminal 10. The user terminal 10 determines whether the first EMR coil 310 or the second EMR coil 320 is to be selected according to a user's gesture by sensing a change in the magnetic field.

FIG. 15 is a diagram illustrating an electronic pen 20 according to another embodiment of the present invention. The electronic pen 20 of FIG. 15 may be configured to operate according to the passive manner but may also be configured to operate according to the active manner.

The electronic pen 20 includes a first input unit 151 and a second input unit 152. When the first input unit 151 is selected, the user terminal 10 of FIG. 3 obtains vector information that represents a direction in which depth in a 3D space increases. When the second input unit 152 is selected, the user terminal 10 obtains vector information that represents a direction in which depth in the 3D space decreases.

In another embodiment, when the second input unit 152 and the first input unit 151 are sequentially selected, i.e., when a sweep-down gesture is performed, the user terminal 10 obtains the vector information that represents the direction in which depth in the 3D space decreases. When the first input unit 151 and the second input unit 152 are sequentially selected, i.e., when a sweep-up gesture is performed, the user terminal 10 obtains the vector information that represents the direction in which depth in the 3D space decreases.

When the electronic pen 20 is configured to operate according to the passive manner, the first input unit 151 and the second input unit 152 correspond to the first EMR coil 310 and the second EMR coil 320 of FIG. 5, respectively. When the electronic pen 20 is configured to operate according to the active manner, each of the first input unit 151 and the second input unit 152 may be embodied as a button or a touch sensor configured to generate an electrical signal.

In another embodiment, the electronic pen 20 may be embodied as an optical pen or an ultrasound pen, but is not limited thereto.

The user terminal 10 may be embodied as a Head Mounted Display (HMD). In this case, a user sees that a 3D screen is located in the air in a real space. Thus, the degree of a realism that a user may sense is lowered when an object is selected and controlled in the air. According to one embodiment of the present invention, an actuator may be installed in the electronic pen 20 and various types of haptic feedback may be provided according to types of events for selecting and controlling an object, thereby increasing realism. Also, an HMD may include a camera module to detect the location of a user's hand or the electronic pen 20. In this case, the camera module may operate in association with a 3D screen image.

As described above, according to the one or more of the above embodiments of the present invention, a value ‘z’ corresponding to the z-axis may be conveniently controlled in a 3D space through a user's sweeping up or down gesture across an electronic pen, and a 3D drawing function may be intuitively performed according to the user's experience.

In addition, other embodiments of the present invention can also be implemented through computer-readable code/instructions in/on a medium, e.g., a computer-readable medium, to control at least one processing element to implement any above-described embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs or DVDs), and transmission media such as Internet transmission media. Thus, the medium may be such a defined and measurable structure including or carrying a signal or information, such as a device carrying a bitstream according to one or more embodiments of the present invention. The media may also be a distributed network, so that the computer-readable code is stored/transferred and executed in a distributed fashion. Furthermore, the processing element could include a processor or a computer processor, and processing elements may be distributed and/or included in a single device.

It should be understood that the embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method of drawing a three-dimensional (3D) object on a user terminal, the method comprising:
displaying a 3D space including a two-dimensional (2D) or 3D object on the user terminal;
obtaining vector information regarding a depthwise direction in the 3D space based on a user's gesture performed across a body of an electronic pen; and
performing a 3D drawing function on the 2D or 3D object, based on the vector information.

2. The method of claim 1, further comprising:
displaying a virtual nib of the electronic pen in response to a 2D input performed by contact by the electronic pen on a screen of the user terminal; and
selecting the 2D or 3D object by moving the virtual nib in the depthwise direction in the 3D space according to the user's sweeping up gesture or sweeping down gesture across the body of the electronic pen.

3. The method of claim 2, further comprising providing haptic feedback via the electronic pen or the user terminal, when the virtual nib contacts the 2D or 3D object.

4. The method of claim 1, wherein performing the 3D drawing function comprises extruding the object in a direction that becomes close to the electronic pen or in a direction that becomes distant from the electronic pen, according to a direction indicated in the vector information.

5. The method of claim 4, further comprising obtaining motion information regarding the electronic pen as the electronic pen separates from the user terminal, and
wherein performing the 3D drawing function comprises extruding the 2D or 3D object while changing a cross-sectional area of the 2D or 3D object based on the motion information.

6. The method of claim 1, further comprising displaying a 3D tool for controlling a view of the 3D space, when a touch input that is different from an input using the electronic pen is sensed by the user terminal.

7. The method of claim 1, wherein, according to a size or direction indicated in the vector information, performing the 3D drawing function comprises performing one of:
an effect of absorbing at least a portion of the 2D or 3D object into the electronic pen;
an effect of extracting a color of the 2D or 3D object;
an effect of shrinking or expanding a shape of the 2D or 3D object;
an effect of increasing or decreasing a volume of the 2D or 3D object; and
an effect of ejecting a portion of the 2D or 3D object absorbed into the electronic pen beforehand or a color of the 2D or 3D object extracted beforehand, from a virtual nib of the electronic pen.

8. The method of claim 1, wherein performing the 3D drawing function comprises:
inserting a virtual nib of the electronic pen into the 2D or 3D object when the vector information indicates a direction in which depth in the 3D space increases; and
performing an effect of sculpting the 2D or 3D object according to a motion of the virtual nib.

9. A non-transitory computer-readable recording medium having recorded thereon a program for performing a method of a method of drawing a three-dimensional (3D) object on a user terminal, the method comprising:
displaying a 3D space including a two-dimensional (2D) or 3D object on the user terminal;
obtaining vector information regarding a depthwise direction in the 3D space based on a user's gesture performed across a body of an electronic pen; and
performing a 3D drawing function on the 2D or 3D object, based on the vector information.

10. A user terminal comprising:
a user interface configured to display a three-dimensional (3D) space including a two-dimensional (2D) or 3D object; and
a processor configured to obtain vector information regarding a depthwise direction in the 3D space based on a user's gesture performed across a body of an electronic pen, and perform a 3D drawing function on the 2D or 3D object based on the vector information.

11. The user terminal of claim 10, wherein the processor displays a virtual nib of the electronic pen on the user interface in response to a 2D input performed by contact by the electronic pen, and selects the 2D or 3D object by moving the virtual nib in the depthwise direction in the 3D space according to the user's sweeping up gesture or sweeping down gesture across the electronic pen.

12. The user terminal of claim 11, wherein the processor outputs a control signal for providing haptic feedback via the electronic pen or the user terminal, when the virtual nib contacts the object.

13. The user terminal of claim 10, wherein the processor extrudes the 2D or 3D object in a direction that becomes close to the electronic pen or a direction that becomes distant from the electronic pen, according to a direction indicated in the vector information.

14. The user terminal of claim 13, wherein the processor obtains motion information regarding the electronic pen as the electronic pen separates from the user terminal, and extrudes the 2D or 3D object while changing a cross-sectional area of the 2D or 3D object based on the motion information.

15. The user terminal of claim 10, wherein the processor displays a 3D tool for controlling a view of the 3D space on the user interface, when a touch input that is different from an input using the electronic pen is sensed by the user interface.

16. The user terminal of claim 10, wherein, according to a size or direction indicated in the vector information, the processor performs of the 3D drawing function by performing one of:
an effect of absorbing at least a portion of the 2D or 3D object into the electronic pen;
an effect of extracting a color of the 2D or 3D object;
an effect of shrinking or expanding a shape of the 2D or 3D object;
an effect of increasing a volume of the 2D or 3D object; and
an effect of ejecting the 2D or 3D object absorbed into the electronic pen beforehand or a color of the 2D or 3D object extracted beforehand, from a virtual nib of the electronic pen.

17. The user terminal of claim 10, wherein the processor inserts a virtual nib of the electronic pen into the 2D or 3D object and performs an effect of sculpting the 2D or 3D object according to a motion of the virtual nib, when the vector information indicates a direction in which depth in the 3D space increases.

18. The user terminal of claim 10, wherein the user interface obtains either the vector information or motion information regarding a physical motion of the electronic pen by using ElectroMagnetic Resonance (EMR).

19. The user terminal of claim 10, further comprising a communication interface for receiving the vector information from the electronic pen.

20. The user terminal of claim 10, wherein the electronic pen comprises:
an actuator for providing haptic feedback to a user;
a sensor unit for sensing at least one among acceleration, a rotation angle, and an inclination; and
a touch panel for sensing the user's gesture.
